(19) United States
(12) Patent Application Publication
(10) Pub. No.: US 2024/0227657 A9
(43) Pub. Date: Jul. 11, 2024

(54) UNIVERSAL ACCESSORY SURFACE MOUNT

(71) Applicant: Outlier Campers LLC, Cambridge, MA (US)

(72) Inventors: Mario Biscaro, Blainville (CA); Steeven Gilbert, Montreal (CA); Ananda Wickramasekera, Cambridge, MA (US)

(21) Appl. No.: 18/366,103

(22) Filed: Aug. 7, 2023

Related U.S. Application Data
(60) Provisional application No. 63/419,234, filed on Oct. 25, 2022.

(51) Int. Cl. B60P 3/36; F16B 11/00

(52) U.S. Cl. CPC B60P 3/36; F16B 11/006; F16B 2200/503

(57) ABSTRACT

Provided is a universal accessory surface mount that allows a broad range of accessories to be attached to the ceilings, walls, and/or flat surfaces of vehicles or campers, or surfaces. The surface mount may have a flange having two sides. The flange may comprise a central insert that is open and recessed on one of the two sides and closed on the other of the two sides. The central insert may be threaded internally and configured to be threaded by a screw.

### PRIORITY CLAIM

The application is based on and claims priority to U.S. Provisional Application No. 63/419,234, filed Oct. 25, 2022, which is expressly incorporated herein by reference thereto.

### TECHNICAL FIELD

Embodiments of the present invention generally relate to a surface mount comprising a flange having two sides.

### DESCRIPTION OF RELATED ART

Current vehicle, rooftop tent, rooftop camper, camper trailer, or recreational vehicle ceilings, walls, and other surfaces may have devices permanently mounted to them, such as lights or fans. These items must either be mounted in areas where they do not cause an obstruction or injury; or if space is limited, they must be mounted relatively flush with a surface, limiting their size, or must be foldable such that they may not cause injury to a person or otherwise be obstructive. In certain tents or collapsible campers, such as rooftop tents, rooftop campers, or pop-up campers, any items mounted to the ceiling must be relatively flush with it or foldable, such that when the tent or camper is folded or collapsed for storage, any devices or accessories that remain attached its surfaces do not interfere with or damage any other items, such as a mattress or other object, or impede the folding or closing procedure of the tent or camper. Some vehicles or camper ceilings and walls may provide mounts that may dangle (e.g., a hanging hook or loop) and be capable of being easily moved out of the way such that they are not an obstruction or may not cause injury if they're struck or come in contact with a person or object (e.g., for hanging certain items such as lights or fans); however, these items may be knocked loose and/or may not remain in a desired, fixed position. Or the mounts may be nonmoving, fixed mounts but may substantially protrude from the camper surface, and any items attached to them may still not remain in position if those items are loosely attached. It may be desirable to lay down on the mattress of a camper to view a screen (e.g., a phone, tablet, or television screen) parallelly mounted relative to the ceiling, or rest against a camper wall to view a screen parallelly mounted relative to the opposite wall, or rest on a camper mattress or against a camper wall to view a screen suspended or mounted at various angles relative to the ceiling or wall. It may also be beneficial to have a fan mounted such that its position does not move when turned on, in an undesirable manner, as may happen if mounted loosely, for example. It may also be beneficial to mount a projector such that it too does not have unwanted movement when projecting an image onto a screen or wall. However, in current campers and rooftop tents, hooks or attachments in the ceiling and other surfaces that are not obtrusive may not be suitable for certain devices and accessories if those items cannot be quickly, easily, and temporarily attached in a fixed position, without unwanted movement. An accessory mount in the ceiling, wall, or other surface of a vehicle or camper that may allow for temporary, quick, and easy attachment of devices and accessories in a desirable position; that may not protrude or may not substantially protrude from that surface in such a way that it may injure a person, damage an object, or impede the opening and closing procedures of a collapsible camper or tent; and may allow for universal attachment of a wide variety of current and future devices and accessories with provisions to prevent damage to the surface by overextension of a screw or prevent damage to the accessory mount and/or surface by limiting over-torquing of a screw is described herein.

Without being able to anticipate which accessories or devices consumers may wish to attach to the surfaces of vehicles and recreational vehicles, trailers and campers, and rooftop campers and tents; or not knowing what adapters may be required to attach accessories and devices of various sizes and shapes, many surfaces in these vehicles, campers, and tents are not manufactured with preinstalled or preexisting universal accessory mounts. For example, many vehicles and campers do not come manufactured from the factory with mounts in or on the dashboard, ceiling, console, or any other surface to mount universal accessories. Devices such as phones, tablets, fans, among other devices, require suction mounts, attachment by adhesive, or require drilling into finished surfaces in vehicles, campers, and rooftop tents to install devices and/or their mounts. Even if after-market universal accessory mounts may be fixed to a finished surface, post-production, many of those accessory mounts are not flush and may interfere with the intended function of that surface. For example, some universal accessory mounts that require a ball, or other component, may protrude substantially from the surface to which they're attached changing the look and function of that surface. It would be beneficial for manufacturers to install 1 or more universal accessory mounts in logical positions (e.g., in the center and/or at various other points in a ceiling, dashboard, console, table, or other surface in a vehicle, camper, or rooftop tent) that does not stick out or does not stick out much from the surface. If the accessory mounts are never used or rarely used, they may still not be very noticeable or may blend into the surface. Currently no manufacture of vehicles or campers simply builds a screw hole into a surface “just in case” a consumer wants to mount something to it. It would be beneficial if vehicles, campers, and/or rooftop tents come with one or more surfaces with one or more points to mount any device that currently exists or may exist in the future. Camera tripod mounts, typically on the underside of the camera housing, allow attachment of screws, however they are specifically designed for mounting the device to tri-pods and/or other mounts. It is not anticipated that one may screw anything else into these holes besides camera mounts and/or other camera accessories.

### SUMMARY OF THE INVENTION

A universal accessory surface mount that allows a broad range of accessories to be attached to the ceilings, walls, and/or flat surfaces of vehicles or campers, or surfaces is provided. An accessory mount that: 1) may be flush with, recessed into, or fixed onto a ceiling, wall, or other surface such that it may not protrude or may not substantially protrude from a surface (e.g., ceiling, walls, or other surfaces of a passenger vehicle, rooftop tent, rooftop camper, camper trailer, or recreational vehicle); and 2) may allow for quick and easy attachment of a variety of devices, accessories, and/or device and accessory holders or mounts with universal sized screw attachments or adapters (e.g. adapters that fit other types and sizes of screws, threaded screw inserts or holes, magnetic mounts, or other attachment types); 3) may prevent a screw inserted into it from damaging the surface by over extension; and 4) may be anchored to the surface by additional screws or other attachment mechanisms to prevent over torquing of a screw in such a way that it may break the accessory mount from the surface to which it is attached. It may be beneficial for quick, easy, and temporary attachment of certain devices and accessories to ceilings, walls, or other surfaces of vehicles; campers; or tents with rigid ceilings, rigid walls, and/or other rigid surfaces, particularly where space is limited. Since it may be difficult to anticipate what types, sizes, and shapes of devices one may wish to attach to the surfaces of vehicles, campers, or other walls and surfaces and/or anticipate what future devices one may wish to attach, it would be beneficial to provide a standard attachment point for which to attach a wide variety of accessories and devices or their specific mounts or holders. Devices and accessories such as cell phones, tablets, fans, lights, storage nets, projectors, and/or other devices or accessories may be easily attached to and detached from vehicle and camper surfaces provided there is a preinstalled or preexisting attachment point or mount that can accommodate their attachment for use. Devices and accessories, including any adapters, may be quickly screwed in by hand for secure attachment to the universal accessory surface mount, when needed, and may be quickly unscrewed by hand for removal and storage. When not in use, no part of the universal surface accessory mount may protrude or substantially protrude from the ceiling, wall, or other surface such that it may injure a person, damage another object, or otherwise be obtrusive. A universal accessory surface mount that contains a single, threaded insert may also be small enough such that when not in use, may offer a better aesthetic or may be less noticeable (e.g., in the headliner of a vehicle or on its dashboard, or on the ceilings or walls of a camper). A universal accessory surface mount with a standard (e.g., standard size and type) threaded insert or screw hole may allow for a broad range of accessories that may be mounted to it, including adapters to accommodate other screw sizes and types or threaded inserts. A universal accessory surface mount with a closed back may prevent over extension of screws that may prevent accidental damage to a surface. A universal accessory surface mount with additional mounting screws or attachment points may further prevent objects, such as screws, inserted into to be over tighten and turned too far causing the accessory mount to loosen from the surface to which it is attached. The accessories mounted to the universal accessory surface mount may themselves be mounts such as magnets, clamps, or other types of device holders. A plurality of universal accessory surface mounts may allow for multiple devices and/or accessories to be simultaneously mounted and/or may work in concert to attach a larger device or accessory that may span or require multiple accessory mounts, such as a storage net, television screen, or some other larger device. Since the universal accessory surface mount may not protrude or substantially protrude from the surface to which it is attached, one or more surface mounts may not impede the normal function of the flat surface or opening and closing procedures of collapsible campers and tents or provide an obstruction on the surface.

A universal accessory surface mount that contains a threaded insert and may offer quick and easy attachment and detachment of a wide variety of accessories and devices, including their mounts; allows for attachment of accessories and devices using a standard screw size or allows for use of adapters to accommodate other types and sizes of screws, threaded screw holes, magnets, and/or other types of attachment mechanisms; is attached to a surface in such a manner that it is recessed into the surface, flush with the surface, or fixed onto the surface in such a way that it does not protrude or does not substantially protrude beyond the surface to which it is attached; and has a closed back so that a screw may not be over extended causing damage to the surface to which the accessory mount is attached; and has anchoring screws holes or attachment points to prevent over-torquing of the accessory mount by screwing something into it that may cause the mount to break loose of the surface to which it is attached is described herein.

A universal accessory surface mount that: 1) may be configured as an open, threaded receptacle on one end, such that it may accept a standard screw size or may accept adapters to make it compatible with other screw sizes and/or types, threaded screw holes, magnets, and/or other attachment mechanisms in devices; 2) may be closed on the other end, such that a screw inserted into it may not overextend beyond the accessory mount causing damage to the surface to which it is attached or cause damage to any object behind the surface; and 3) may contain holes that allow secure attachment of the accessory mount to a surface. It may be further configured as a threaded insert that may be fixed inside a cavity or hole in the ceiling, walls, or other surfaces of vehicles, including recreational vehicles; campers, including camping trailers, rooftop campers, and pop-up campers; and tents, including hard- and soft-shelled rooftop tents with a rigid surface or frame to mount objects. It may alternatively be configured as a relatively flat component with a threaded insert or screw hole that may be fixed onto a surface, without the need for a hole or cavity, and is shallow enough that it may not protrude substantially from that surface. The universal accessory surface mount may be fixed to a surface such that it may be recessed into the surface; may be flush with the surface; or may not substantially protrude from the surface in a manner that may make it an obstruction or cause injury when no device or accessory is attached to it. Given the relatively small size of the threaded insert in the universal accessory surface mount, it may be configured such that it is relatively inconspicuous, offering an aesthetic benefit, when not in use.

The universal accessory surface mount may be permanently fixed by adhesive, screws, or by some other method to attach it to a surface or recess it into a surface. A benefit of this type of accessory mount is that when it is not in use, it may not cause an obstruction or potentially hazardous projection from a surface, may not impede the movement of ceilings and walls in collapsible campers or tents, and may not otherwise affect the normal functioning of surfaces. A further benefit of such an accessory mount is that it may be configured such that it is small enough, recessed enough, or substantially concealed that it may not substantially and adversely affect the aesthetics of the surface to which it is attached. By turning a thumb screw or other type of screw or by screwing in an entire device with a fixed screw attached to it, useful items may be quickly and easily attached to the universal accessory surface mount for use or may be quickly and easily detached to allow the surface to return to its normal function and appearance. Or items may be semi-permanently attached using screws but, if desired, may be removed, returning the surface to its original appearance and function.

In some embodiments, a surface mount is provided. The surface mount may have a flange having two sides. The flange may comprise a central insert that is open and recessed on one of the two sides and closed on the other of the two sides. The central insert may be threaded internally and configured to be threaded by a screw. The central insert may be closed and protruded on the other of the two sides. The central insert may be configured to be threaded by a screw from the open side. The surface amount may further include a hole through the two sides. The surface mount may further include a plurality of holes. The surface mount may further include a screw or bolt that fits the hole. The central insert may be configured to accept a standard size screw. The central insert may be configured to accept a male-to-female adapter or a male-to-male adapter. The central insert may be configured to accept a magnetic adapter. The flange and the central insert may be circular. The surface mount may further include a surface to which the surface mount is attached. The surface may include a clearance hole on the surface configured to receive the central insert of the surface mount. The surface mount may be attached to the surface by an adhesive. The surface mount may further include a hole through the two sides. The screw or bolt may be configured to fit the hole of the surface mount and the hole of the surface. The surface mount may be attached to the surface by the screw or bolt through the hole of the surface mount and the hole of the surface. The surface mount may further include a hole on the surface, the hole being configured to be aligned with the hole of the surface mount. The number of the hole of the surface mount may be the same as the number of the hole of the surface. The surface may be of a vehicle, a camper, or a tent. The camper may be collapsible. The surface may be a ceiling, wall, or other surfaces.

Without being able to anticipate where in a vehicle, camper, and/or rooftop tent a consumer may wish to install a device or accessory, a single or plurality of universal accessory surface mounts may be installed during the manufacturing process onto or into the surfaces of a wide variety of vehicles, campers, and/or rooftop tents such that many devices that exist now or may exist in the future may be attached without any post-production modification to the surface. If the accessory mounts are not used, they may not affect the intended function of the surface or may have limited negative affect on the aesthetic of the surface.

### BRIEF DESCRIPTION OF DRAWINGS

FIG. 1A shows a front view of an exemplary universal accessory surface mount;

FIG. 1B shows a side view of an exemplary universal accessory surface mount;

FIG. 1C shows a rear prospective view of an exemplary universal accessory surface mount;

FIG. 2 shows an exploded view of the universal accessory surface mount of FIGS. 1A-1C fixed to a surface;

FIG. 3A shows a front view of another exemplary universal accessory surface mount;

FIG. 3B shows a side view of another exemplary universal accessory surface mount;

FIG. 3C shows a rear prospective view of another exemplary universal accessory surface mount;

FIG. 4A shows the universal accessory surface mount of FIGS. 3A-3C fixed to a surface.

FIG. 4B shows an exploded view of the universal accessory surface mount of FIG. 3A-3C fixed to a surface.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Described herein are devices, components, assemblies, systems, methods, etc. for universal surface accessory mounts. The description and accompanying figures, which describe and show certain embodiments, are made to demonstrate, in a non-limiting manner, several possible configurations of universal surface accessory mounts, apparatuses, components, assemblies, systems, etc. and various methods of using them according to various aspects and features of the present disclosure. Accordingly, the disclosure is not limited to the specific embodiments described. Rather, the inventive principles associated with the embodiments described herein, including with respect to the apparatuses, devices, components, assemblies, systems, methods, etc. described herein, may be applied in a variety of ways, including to other types of apparatuses, devices, components, assemblies, systems, methods, etc. General and specific apparatuses, devices, components, assemblies, systems, methods, etc. are described herein sufficiently to enable one to develop a variety of implementations/applications without undue experimentation. In the development of particular applications, numerous implementation-specific decisions will be made to achieve the design-specific goals, which will vary from one implementation/application to another. It will be appreciated that, having access to this disclosure and reading this disclosure, such a development effort would be a routine undertaking for persons of ordinary skill in the art.

This document does not intend to distinguish between components that differ in name but not function. In the following discussion and in the claims, the terms “including,” “includes,” “comprising,” “have,” and “has” are used in an open-ended fashion, and thus should be interpreted to mean “including, but not limited to.” The word “or” is used in the inclusive sense (i.e., “and/or”) unless a specific use to the contrary is explicitly stated.

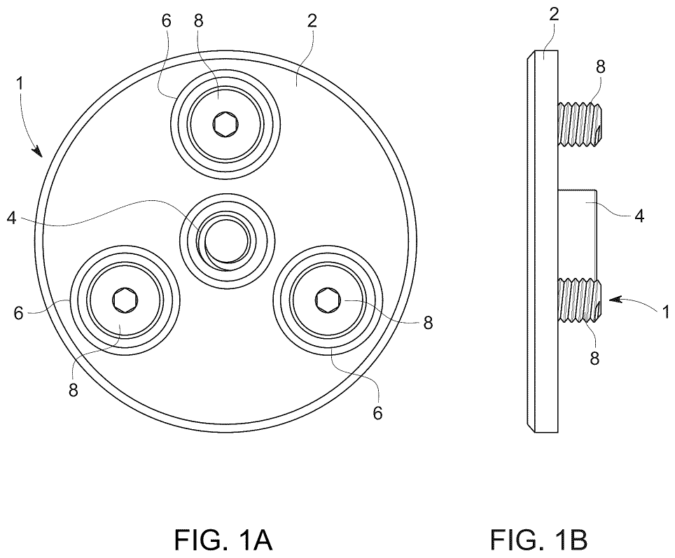

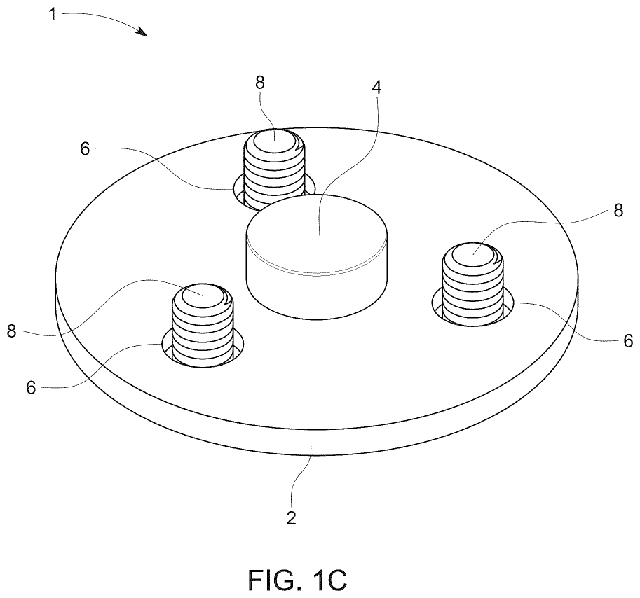

FIGS. 1A-1C shows a front, side, and rear prospective view of an exemplary universal accessory surface mount 1, configured as a flange with a threaded insert that may be fully or partially recessed into a cavity or hole, or fixed behind a hole in a surface, and may be attached using screws. Universal accessory surface mount 1 may contain flange 2 that further contains threaded insert 4 which is open and recessed on one side (i.e., the accessible side) to accept a standard screw size (e.g., a ¼ in-20 screw, or ⅜ in-16 screw, or other standard screw size; preferably, any screw size used for a tripod) in a device or accessory or accept: a male-to-female adapter that may make it compatible with other standard or non-standard screw sizes and/or types in devices or accessories; a male-to-male adapter that may make it compatible with threaded inserts or screws holes in devices or accessories; a magnetic adapter (e.g., a magnet that may be screwed into threaded insert 4 in universal accessory surface mount 1 that may make it compatible with devices and accessories that may stick to magnets (e.g., a phone or table case with a magnetic mount); or any other type of adapter. Threaded insert 4 of universal accessory surface mount 1 may be further configured to be closed and protruding on the other side (i.e., the inaccessible side), such that any screw inserted into universal accessory surface mount 1 may not overextend beyond the mount, causing damage to the surface to which the mount is attached or damaging any object behind the surface to which the mount is attached. And universal accessory surface mount 1 may contain holes for a more secure, permanent attachment to a surface.

Universal accessory surface mount 1 may be attached to a surface (e.g., a ceiling, wall, or other surface of a vehicle, camper, tent with a rigid surface, or any other surface) using screws, adhesive, or some other attachment mechanism. As shown in FIGS. 1A-1C, flange 2 may contain holes 6 (e.g., 1 or more holes) to allow it to be fixed to a surface using screws 8. Holes 6 may allow flange 2 to be screwed, nailed, riveted, or otherwise fastened to a surface, such that threaded insert 4 is recessed, mostly recessed, or partially recessed into the surface, or fixed behind a surface, such that universal accessory surface mount 1 may not protrude or may not substantially protrude from the surface to which it is mounted. Alternatively flange 2, threaded insert 4, or any other part of universal accessory surface mount 1 may be glued (e.g., by use of adhesive) or attached in some other way to a surface.

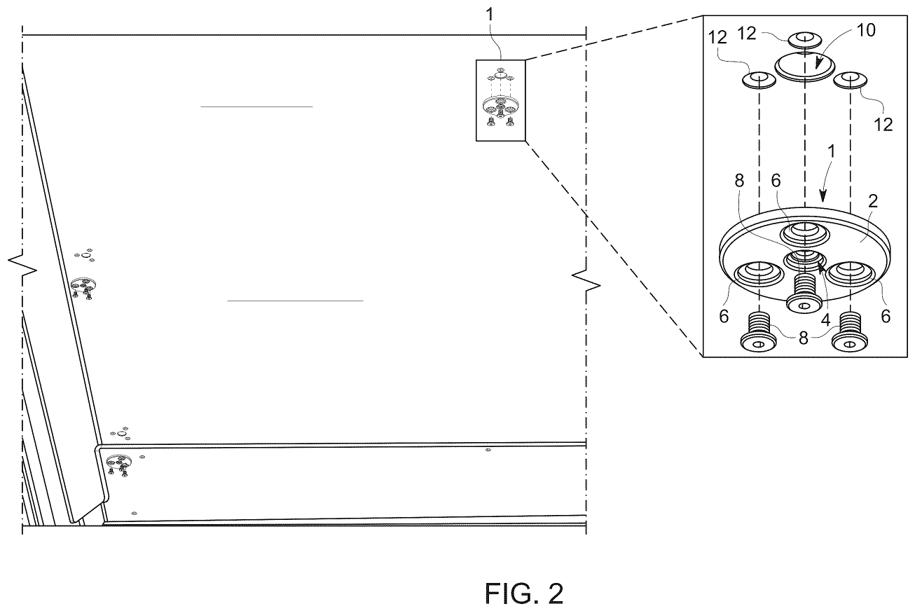

FIG. 2 shows universal accessory surface mount 1 fixed to a surface. As shown in FIG. 2, threaded insert 4 in universal accessory mount 1 aligns with clearance hole 10 in surface 14; holes 6 in universal accessory surface mount 1 align with holes 12 in surface 14; and universal accessory mount 1 is fixed to surface 14 using screws 8 such that flange 2 sits over surface 14 and threaded insert 4 is recessed into clearance hole 10 in surface 14. In this mounting position, universal accessory surface mount 1 may be relatively flush with or may not substantially protrude from surface 14, to which it is fixed.

Alternatively universal accessory surface mount 1 may be fully recessed into a surface such that flange 2 sits flush with or below the surface and threaded insert 4 is fully recessed into clearance hole 10 in the surface. In this mounting position, universal accessory surface mount 1 may not protrude from the surface to which it is fixed.

Universal accessory surface mount 1 may also be mounted behind a surface, such that flange 2 is attached to an interior side of a surface and threaded insert 4 is accessible by a corresponding hole in the surface. In this mounting position, universal accessory surface mount 1 is substantially concealed behind a surface for a better aesthetic effect.

FIGS. 1A-1C and 2 show exemplary universal accessory surface mount 1 configured as circular flange 2 with circular threaded insert 4 that fits into circular clearance hole 10 and is attached by screws 8 through holes 6 and 12. This may prevent universal accessory mount 1 from unwanted turning by the force of over-torquing a screw inserted into it, causing it to potentially break loose from the surface to which it is mounted. Alternatively flange 2 and/or threaded insert 4 may be another shape (e.g., a triangle, rectangle, pentagon, or some other shape) that corresponds to a similarly shaped recess for flange 2 and/or clearance hole 10 for threaded insert 4 in the surface, such that unwanted turning of the universal surface accessory mount may not occur as items are screwed into it, particularly if the universal accessory surface mount is fixed to the surface by adhesive.

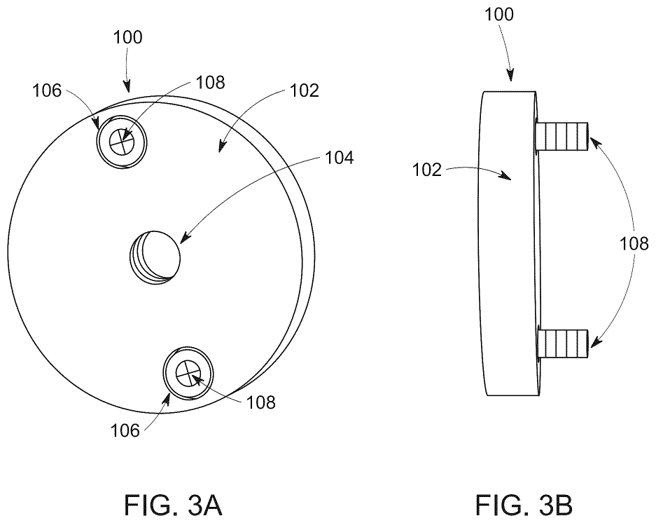

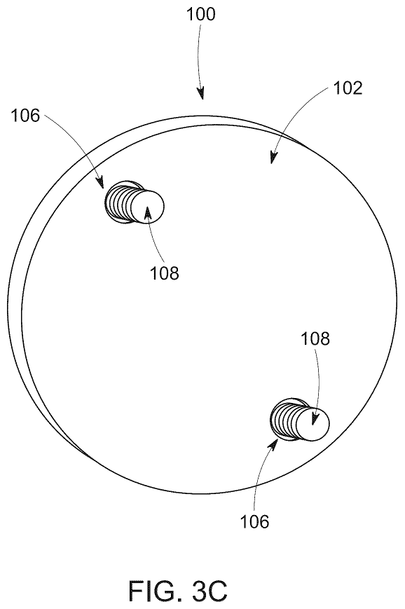

FIGS. 3A-3C shows a front, side, and rear perspective view of another exemplary universal accessory surface mount 100 that is configured as a self-contained disc-shaped unit which may be attached onto an existing, already finished surface, where creating a clearance hole may not be possible or desirable. Universal accessory surface mount 100 contains disk 102 that has threaded insert 104 fully recessed into its own surface, such that the threaded insert does not need a clearance hole in the surface to which universal surface accessory mount 100 is fixed. The back of universal surface accessory surface mount 100 behind threaded insert 104 may be configured to be closed or solid, such that any screw inserted into threaded insert 104 may not extend beyond universal accessory surface mount 100, potentially causing damage to the surface to which it is fixed.

Universal accessory surface mount 100 may be attached to a surface (e.g., a ceiling, wall, or other surface of a vehicle, camper, tent with a rigid surface, or any other surface) using screws, adhesive, or some other attachment mechanism. As shown in FIGS. 3A-3C, disk 102 may contain holes 106 (e.g., 1 or more holes) to allow it to be fixed to a surface using screws 108. Holes 106 may allow disk 102 to be screwed, nailed, riveted, or otherwise fastened to a surface, such that universal accessory surface mount 100 may not substantially protrude from the surface to which it is mounted.

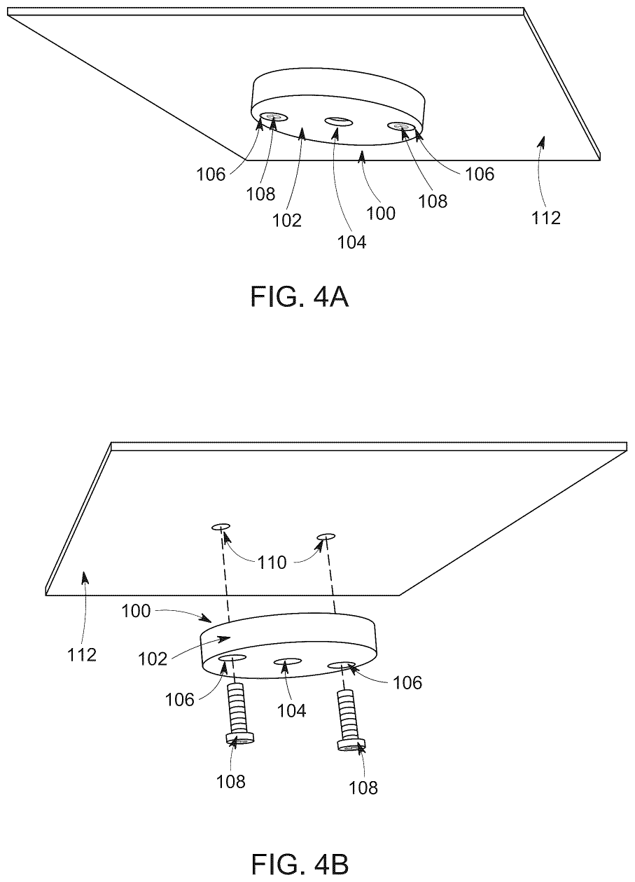

FIGS. 4A-4B shows universal accessory surface mount 100 fixed to a surface. As shown in FIGS. 4A-4B, holes 106 in universal accessory surface mount 100 align with holes 110 in surface 112; and universal accessory mount 100 is fixed to surface 112 using screws 108 such that disk 102 sits over surface 112. In this mounting position, universal accessory surface mount 100 may not substantially protrude from surface 112, to which it is attached.

Alternatively, disk 102 may be glued (e.g., by use of adhesive) or attached in some other way to a surface. FIGS. 3A-3C and 4A-4B show exemplary universal accessory surface mount 100 configured as round disk attached using screws however, universal accessory surface mount 100 may alternatively be another shape (e.g., a triangle, rectangle, pentagon, or a shape with more sides).

What is claimed is:

1. A surface mount comprising:
a flange having two sides, the flange comprising:
a central insert that is open and recessed on one of the two sides and closed on the other of the two sides
wherein the central insert is threaded internally and configured to be threaded by a screw.

2. The surface mount of claim 1, wherein the central insert is closed and protruded on the other of the two sides.

3. The surface mount of claim 1, wherein the central insert is configured to be threaded by a screw from the open side.

4. The surface mount of claim 1, further comprising a hole through the two sides.

5. The surface mount of claim 4, comprising a plurality of holes.

6. The surface mount of claim 4, further comprising a screw or bolt that fits the hole.

7. The surface mount of claim 1, wherein the central insert is configured to accept a standard size screw including a ¼ in-20 screw and a ⅜ in-16 screw.

8. The surface mount of claim 1, wherein the central insert is configured to accept a male-to-female adapter or a male-to-male adapter.

9. The surface mount of claim 1, wherein the central insert is configured to accept a magnetic adapter.

10. The surface mount of claim 1, wherein the flange and the central insert are circular.

11. The surface mount of claim 1, further comprising:
a surface to which the surface mount is attached.

12. The surface mount of claim 11, wherein the surface comprises a clearance hole on the surface configured to receive the central insert of the surface mount.

13. The surface mount of claim 11, wherein the surface mount is attached to the surface by an adhesive.

14. The surface mount of claim 11, further comprising a hole through the two sides.

15. The surface mount of claim 14, wherein the screw or bolt is configured to fit the hole of the surface mount and the hole of the surface.

16. The surface mount of claim 14, wherein the surface mount is attached to the surface by the screw or bolt through the hole of the surface mount and the hole of the surface.

17. The surface mount of claim 14, wherein the surface further comprises a hole on the surface, the hole being configured to be aligned with the hole of the surface mount.

18. The surface mount of claim 15, wherein the number of the hole of the surface mount is the same as the number of the hole of the surface.

19. The surface mount of claim 11, where the surface is of a vehicle, a camper, or a tent.

20. The surface mount of claim 11, wherein the camper is collapsible.

21. The surface mount of claim 11, where the surface is a ceiling, wall, or other surfaces.
